(19) United States
(12) Patent Application Publication
(10) Pub. No.: US 2003/0055560 A1
(43) Pub. Date: Mar. 20, 2003

(54) Method and apparatus for wireless vehicle location

(76) Inventor: Marc S. Phillips, San Diego, CA (US)

Correspondence Address: Sarah Kirkpatrick, Manager, Intellectual Property Aministration, QUALCOMM Incorporated, 5775 Morehouse Drive, San Diego, CA, 92121-1714, US

(21) Appl. No.: 09/957,814

(22) Filed: Sep. 20, 2001

(51) Int. Cl. G01S 3/02

(52) U.S. Cl. 701/213; 342/357.07; 342/457

(57) ABSTRACT

A novel and improved method and apparatus for locating a vehicle is disclosed. In one aspect, the disclosed method and apparatus may include a terminal configured to receive vehicle location information from a vehicle over a communication link, compare the vehicle location information with the location of the terminal, and display information to a user enabling the user to locate the vehicle.

### BACKGROUND OF THE DISCLOSURE

I. Field

The present disclosure relates to wireless tracking and communication, and in particular, to a novel and improved vehicle location method and apparatus.

II. Background

Few people have escaped the inconvenience and embarrassment of forgetting where they parked their car. Whether in a parking lot at a shopping mall, airport, or work, today's ubiquitous sport utility vehicles and luxury sedans can blend together into an unrecognizable sea of glass and metal.

In the rush to get to one's destination, the driver may forget to note the parking space's location designation. Upon return, the driver may resort wandering the parking lot in a directionless quest for their vehicle, or the driver may resort to sounding the vehicle's alarm in a vain effort at location if one is installed.

In certain areas, wandering around a large parking lot may expose to user to risks such as theft or crime.

Hence, there is a need for an improved vehicle location system that solves the deficiencies of the prior art.

### SUMMARY

A novel and improved system for locating a vehicle is disclosed. In one aspect, the system may comprise a terminal configured to receive vehicle location information from a vehicle over a communication link, compare the vehicle location information with the location of the terminal, and display information to a user enabling the user to locate the vehicle.

A novel and improved method for enabling a user to locate a vehicle using a terminal is also disclosed. One aspect of the disclosed method comprises: determining, by a position location server, a vehicle's location; sending, by the position location server, the vehicle's location to the terminal; comparing, by the terminal, the location of the terminal to the vehicle's location; and displaying, by the terminal, location information enabling the user to locate the vehicle.

A further disclosed method comprises determining, by the vehicle, its location; sending, by the vehicle, the location to the terminal over a communications link; comparing, by the terminal, the location of the terminal to the vehicle location; and displaying, by the terminal, location information enabling the user to locate the vehicle.

Further aspects include displaying the location of the terminal in relation to the location of the vehicle on the display area; displaying the location of the terminal and the location of the vehicle.

The disclosed system may further display a distance indicator and an altitude indicator. Further aspects of the disclosed system may overlay a map on the display, and display a pointer configured to direct the user to the vehicle.

Another aspect of the disclosed system may display a vector pointer for indicating both the direction and distance needed to arrive at the vehicle, and display the vector pointer in relation to the user's direction of travel.

The disclosed system may be CDMA-compliant, and be disposed within a GPS environment.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a flowchart of a method according to the present invention.

FIG. 2 is a diagram of a location system according to the present invention.

FIG. 3 is a diagram of a vehicle according to the present invention.

FIG. 4 is a diagram of a terminal according to the present invention.

FIG. 5 is a operational block diagram of a terminal according to the present invention.

FIGS. 6A-6C are illustrations of a display according to the present invention.

FIGS. 7A-7B are further illustrations of a display according to the present invention.

### DETAILED DESCRIPTION

Persons of ordinary skill in the art will realize that the following description is illustrative only and not in any way limiting. Other modifications and improvements of the invention will readily suggest themselves to such skilled persons having the benefit of this disclosure.

It is contemplated that the various aspects of the disclosure may be embodied in various computer and machine readable data structures. Furthermore, it is contemplated that data structures embodying various aspects of the disclosure may be transmitted across computer and machine-readable media, and through communications systems by use of standard protocols such as those used to enable CDMA-based communication systems.

The disclosure may further relate to machine-readable media on which are stored embodiments of various aspects of the disclosure. It is contemplated that any media suitable for storing instructions related to aspects of the disclosure is within the scope of the present disclosure. By way of example, such media may take the form of magnetic, optical, or semiconductor media.

Various aspects of the disclosure may be described through the use of flowcharts. Often, a single instance may be shown. As is appreciated by those of ordinary skill in the art, however, the protocols, processes, and procedures described herein may be repeated continuously or as often as necessary to satisfy the needs described herein. Accordingly, the representation of various aspects of the disclosure through the use of flowcharts should not be used to limit the scope of the present disclosure.

Exemplary embodiments of disclosed apparatus and methods may be disclosed herein. The word “exemplary” is used exclusively herein to mean “serving as an example, instance, or illustration.” Any embodiment described as an “exemplary embodiment” is not to be construed as necessarily preferred or advantageous over other embodiments described herein.

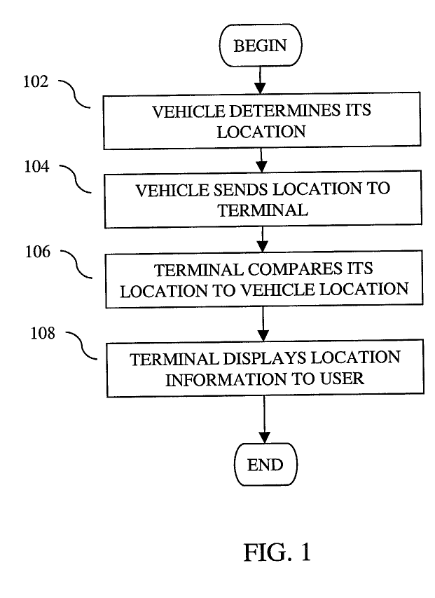

Referring now to FIG. 1, a flowchart of one aspect of the present disclosure is shown. The process of FIG. 1 begins in act 102, where a vehicle configured in accordance with one aspect of the present disclosure determines its location. This act may be triggered by any number of events, such as the vehicle being shut off, or a user activating a button or other switching means. Various methods and structure for determining the vehicle's location will be discussed below.

Then, in act 104, the vehicle will provide its location information to a terminal configured in accordance with the present invention. In one aspect of the present disclosure, the location information is transmitted over a wireless communication link. It is contemplated that a wide variety of communication protocols may be suitable for use, such as Bluetooth®. Furthermore, various aspects of the present disclosure may utilize cellular communication standards, such CDMA. Further communication methods and structure will be discussed in more detail below.

Then, in act 106, the terminal will determine its own location, and compare its location against the location of the vehicle previously received. It is contemplated that a terminal configured in accordance with the present disclosure may employ a wide variety of position location techniques, as will be described more fully below.

Having determined the difference in location between the terminal and the vehicle, the terminal may then display location information enabling the user to locate their vehicle in act 108. It is contemplated that the location information may be displayed in any number of useful manners as will be shown and described below.

Exemplary Structure

Exemplary structure suitable for use with various aspects of the present disclosure will now be disclosed.

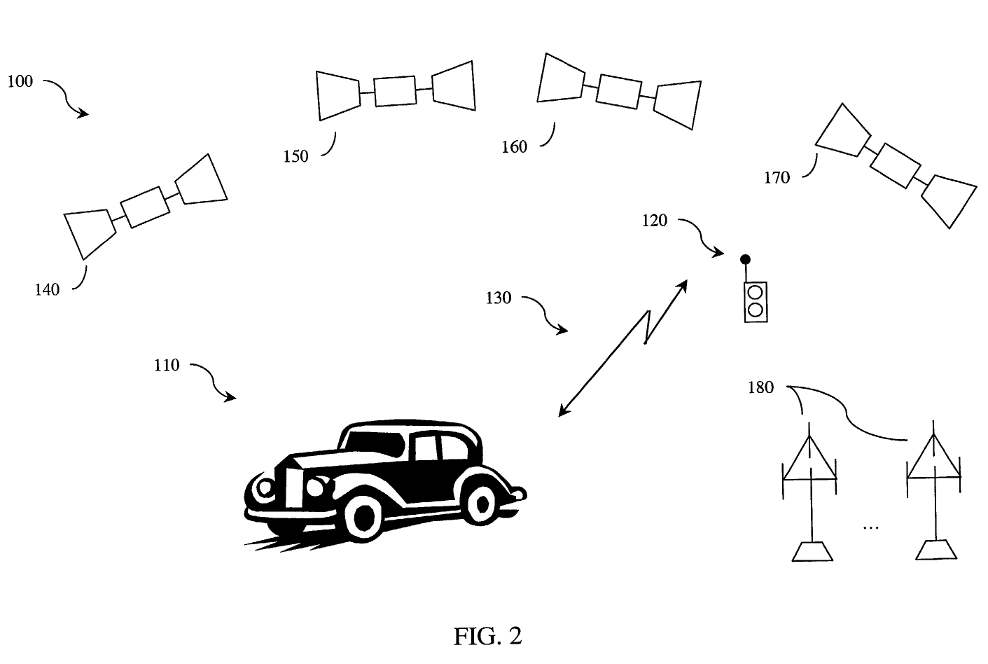

Turning now to FIG. 2, a conceptual diagram of a vehicle location system 100 according to one aspect of the disclosure is shown. The system 100 of FIG. 2 includes a vehicle 110 configured to communicate with terminal 120 over a communication link 130. In one aspect of the present disclosure, the system 100 is configured to determine the location of both the vehicle 110 and the terminal 120. When activated by a user, the system 100 may be configured to provide the location of the vehicle 110 to the terminal 120 through the link 130. The terminal 120 is then configured to display vehicle location information and aid the user in locating their vehicle.

The system 100 of FIG. 2 may be disposed in a GPS (Global Positioning System) environment having several GPS satellites, of which four are shown (140, 150, 160, and 170). Such GPS environments are well known. See for example Hofmann-Wellenhof, B., et al., GPS Theory and Practice, Second Edition, New York, N.Y.: Springer-Verlag Wien, 1993.

Those of ordinary skill in the art will appreciate that the present teachings may be applied to other communication systems, such as advanced mobile phone system (AMPS), Global system for mobile communications (GSM), etc. without departing from the scope of the present invention.

The disclosed system 100 may also include a wireless communication system including an external signal source, such as a from a plurality of base stations 180 or the satellites 140, 150, 160, and 170 of a wireless code division multiple access (CDMA) communication system.

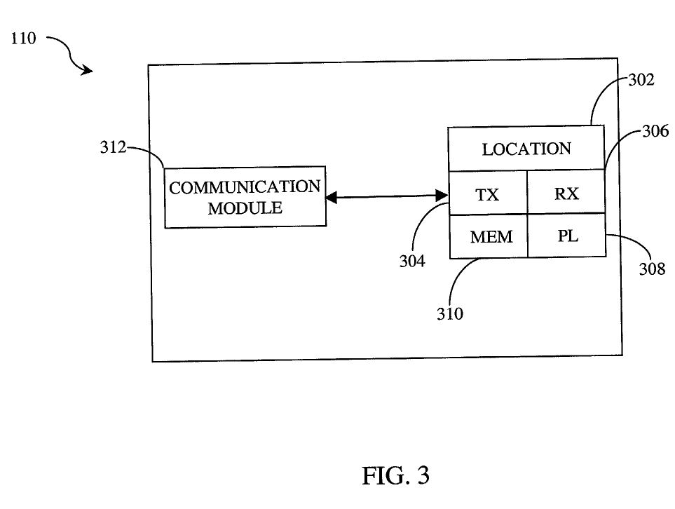

Referring now to FIG. 3, a more detailed diagram of a vehicle 110 is shown.

The vehicle 110 may include a location module 302 for determining the location of the vehicle. The location module 302 may also include transmitting means (TX) 304 and receiving means (RX) 306. The location module may be operatively disposed within the vehicle 110 at any convenient location.

The location module 302 may further include a position location processor 308. The position location processor 308 is configured to analyze signals received from a position location system through the receiver and determine the location of the vehicle. The location module 302 may further include memory 310 for storing the vehicle's location information.

It is contemplated that location processor 308 may be configured to use any position location techniques known in the art.

For example, methods for performing position location on a strictly CDMA terrestrial system with no satellites required are known in the art. Such methods useful in the present application are disclosed in U.S. Pat. Nos. 5,646,632 and 5,900,838 to Khan, et al., in U.S. Pat. No. 6,134,228 to Cedervall, and in U.S. Pat. No. 6,034,635 to Gilhousen, all assigned to the assignee of the present disclosure and incorporated by reference as through fully set forth herein.

Furthermore, various aspects of the present disclosure may be configured to allow the position of a mobile unit to identified using a minimum number of GPS satellites. It is contemplated that any GPS-based location system known in the art may be used in the present disclosure, such as gpsOne. Further methods useful in the present disclosure include U.S. Pat. Nos. 6,081,229, 6,166,685, and 6,188,354 B1 to Soliman, et al.; 6,134,483 to Vayanos et al.; and 6,058,338 to Agashe et al., all assigned to the assignee of the present disclosure and incorporated by reference as through fully set forth herein.

The vehicle 110 of FIG. 3 may further include a communication module for providing communications with the terminal 120. The communications module may also be operatively coupled to the location module 302.

In one aspect of the disclosed system, the communication module 312 may be configured to provide communication according to the Bluetooth protocols. Thus, the communication link 130 of FIG. 2 may comprise a Bluetooth link.

As is known by those of ordinary skill in the art, Bluetooth is protocol for providing point-to-point and point-to-multi-point wireless connectivity between devices. Resources for the Bluetooth protocol may be found at www.bluetooth.com and www.palowireless.com.

When configured to provide Bluetooth connectivity, the communication module 312 may further include a radio unit, a link control unit, and a support unit for providing link management and host terminal interface functions. When so configured, the vehicle 110 may communicate with the terminal 120 up to a distance of 100 m in an unobstructed area such as a parking lot.

One advantage of the Bluetooth protocol is the small packaging footprint required. For example, a two-chip Bluetooth radio system suitable for communicating packets of information over CDMA system is manufactured by SiliconWave.com.

Additionally, it is contemplated that the communication module 312 may be configured to communicate and exchange location information using CDMA protocols. Thus, communication link 130 of FIG. 2 may comprise a CDMA link. Such a system is described in U.S. Pat. No. 5,748,104 to Argyoudis et al., assigned to the same assignee as the present application and incorporated by reference as though fully set forth herein.

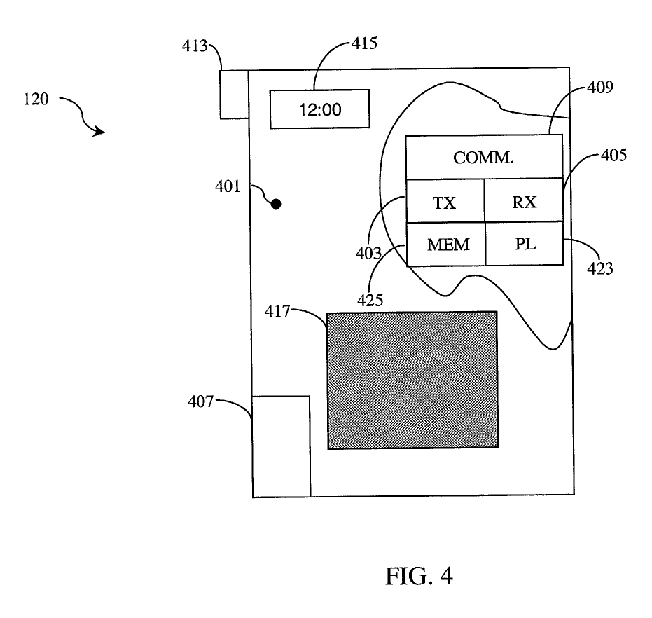

Referring now to FIG. 4, a conceptual diagram of a terminal 200 is shown. Terminal 120 includes a enclosure 401. In one aspect of the present disclosure, the enclosure 401 is small enough to be carried in one's purse or briefcase.

Terminal 120 further includes transmitting means (TX) 403 and receiving means (RX) 405. TX 403 and RX 405 are shown operatively disposed within enclosure 401 in FIG. 4.

Terminal 120 may further include a button 413, which is configured to activate the vehicle's systems.

Terminal 120 may also include a clock 415. The clock 415 may comprise any means for displaying time known in the art, such as a liquid crystal display. The terminal 120 may determine the time displayed using any technique known in the art, including synchronizing itself to system time based on signals received from a base station. Methods for timing synchronization in CDMA communication systems suitable for use with the present invention are disclosed in U.S. Pat. No. 5,872,774, assigned to the same assignee of the present application and incorporated herein by reference.

Terminal 120 may further include a battery 407. In an exemplary non-limiting embodiment, battery 407 comprises a non-removable rechargeable battery disposed within the enclosure 401. Battery 407 may comprise any rechargeable power means known in the art, such as nickel-cadmium, lithium-ion, or nickel metal hydride.

Terminal 120 further includes receiving means RX 405. In yet an exemplary non-limiting embodiment, the RX 405 is operatively coupled to the battery 407 such that the terminal 120 will remain in a low-power standby mode when not in use. The terminal 120 may also save battery power using a slotted paging mode as described in IS-95.

Terminal 120 may further include a position location processor 423. The position location processor 423 is configured to analyze signals received from the system through the receiver and determine the location of the mobile unit.

Terminal 120 may further include memory 425 for storing location information such as coordinates.

Terminal 120 may also include a display area 417 for providing location information to a user. It is contemplated that the display area 417 may comprise any display means known in the art, such as liquid crystal displays and the like. Display area 417 may comprise a color or two-tone display.

The terminal 120 may also include a communication module 409 for providing Bluetooth connectivity if desired. The communication module 409 may be configured substantially as shown and described above for the communication module 312.

As mentioned above, the terminal 120 may also be configured to provide CDMA based services. For example, it is contemplated that the terminal 120 may also serve as a fully-functional CDMA-based cellular telephone additionally configured to provide the features and benefits of the present disclosure.

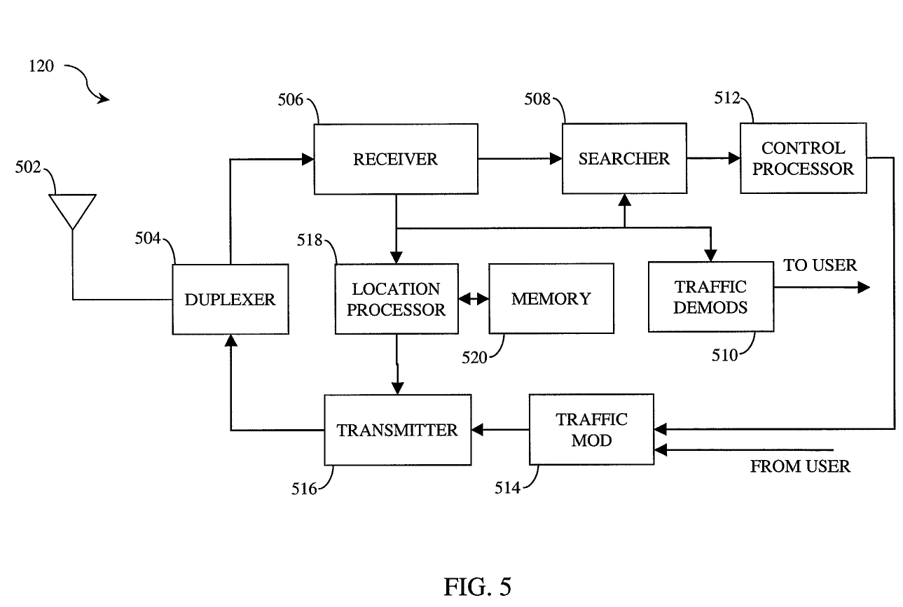

Referring now to FIG. 5, a block diagram of a terminal 120 suitable for use is shown, further including additional structure suitable for providing CDMA-based services.

In one aspect of the disclosed system, the terminal 120 preferably includes a bi-directional antenna 502 adapted to receive CDMA transmissions well as GPS signals. Separate antennas also may be used for receiving and transmitting GPS signals, CDMA signals, and other signals, such as alternative system signals. Alternatively, the system may use other type of wireless interface such as TDMA or analog.

The antenna 502 preferably feeds a duplexer 504. Duplexer 504 preferably feeds a receiver 506 and is preferably fed by a transmitter 508. The receiver 506 provides for radio frequency (RF) down conversion and a first stage of intermediate frequency (IF) down conversion.

In operation, forward link frames of data received from a reference base station are received by antenna 502 and provided through duplexer 504 to receiver 506. The receiver 506 downconverts, filters and amplifies the received signals and provides it to a searcher 508, which searches for pilot channels in accordance with a neighbor list provided by a base station. As is appreciated by those of ordinary skill in the art, the neighbor list is provided as signaling data on the traffic channel from the base station.

A signal indicating the start of received frames from the base station is provided to a control processor 512. The control processor 512 generates and provides a time alignment signal to traffic modulator 514 which aligns the start of frames transmitted from the terminal 120 with the start of frames received by the terminal 120. Received traffic may be provided to the user through traffic demodulator 510.

Frames of user data are provided to traffic modulator 514, which in response to timing signals from the control processor 512, time aligns the frames transmitted through transmitter 516 by way of duplexer 504 with the received frames. The reverse link frames are upconverted, filtered, and amplified by the transmitter 516 through duplexer 504 and antenna 502.

The terminal 120 may further include a location processor 518 for determining the location of the mobile unit and for comparing the location of the terminal 120 to a set of coordinates stored in memory 520. The coordinates may comprise the location of the vehicle 110. The memory 500 may comprise RAM or ROM standard in the art depending upon the desired application of the terminal 120. The position location techniques shown and described above may be employed in the terminal 120.

Operation

Various aspects of operation will now be shown and described.

A vehicle configured in accordance with the present disclosure may determine its current location, and send its current location to a terminal (e.g., cellular phone) configured according to the present invention, preferably via a Bluetooth signal. The vehicle may periodically (e.g., every 5 seconds) transmit this information to terminals registered to receive this service, or it may transmit the information to such terminals at the time the car's engine is shut off, or alternatively it may transmit this information to a terminal only upon a request/poll by the terminal.

As will be appreciated by those of ordinary skill in the art, by having the vehicle communicate directly with the phone, the phone does not have to bring up a call to determine its current location. However, in one embodiment, the terminal could request the current location of the vehicle via a cellular link at any time. In such an embodiment, the terminal may request the location either directly from the car, or from a position location server that is able to determine the location of the car. The position location server may be a gpsOne server, or it could be a server that tracks a vehicle's location by a network-based solution.

When a user realizes that they don't know where their car is, the user may hit a button on their phone. When so activated, the phone may first determine the user's current location. The phone may then compare the user's location to that of the vehicle. For example, the phone may compare the latitude and longitude to that of the vehicle. In one embodiment the phone may use a cached location of the vehicle. In an alternative embodiment the phone will bring up a cellular link to request the current location of the vehicle.

The phone may then display a map which displays the user's location and the vehicle location.

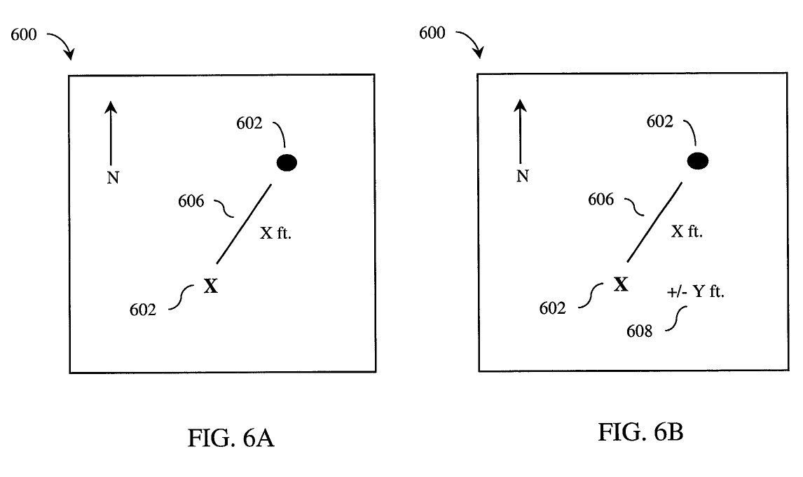

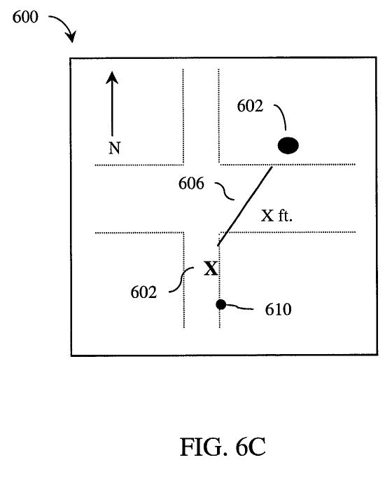

Referring now to FIG. 6A, a diagram of a location display 600 is shown. The display 600 may include a user location indicator 602 and a vehicle location indicator 604. that may be displayed as dots, or any other suitable character. Display 600 may further include a distance indicator 606 appearing as a line between the user and vehicle location indicators 602 and 604, and may further include a numeric indicator for displaying the distance needed to travel by the user to reach their vehicle. The distance may be displayed in any desired units, such as metric or English units. The display 600 may be aligned such that North is oriented towards the top of the phone.

Additionally, if the user's vehicle is located at a different altitude or height, as in the case of a parking structure, a separate altitude indicator 608 may appear on the display 600 showing the distance that the user must travel either up or down to be on the same floor as their car. Such an embodiment is shown in FIG. 6B.

To make the disclosed system more useable, it is contemplated that a map 610 may be overlaid on the display 600, as shown in FIG. 6C. For example, maps of the parking lot or the mall may be overlaid atop of the user and vehicle location indicators 602 and 604 to aid the navigation of the user. It is contemplated that if the map 610 is of a high enough quality, the line 606 may be removed from the display 600. It is contemplated that any mapping protocols known in the art may be utilized.

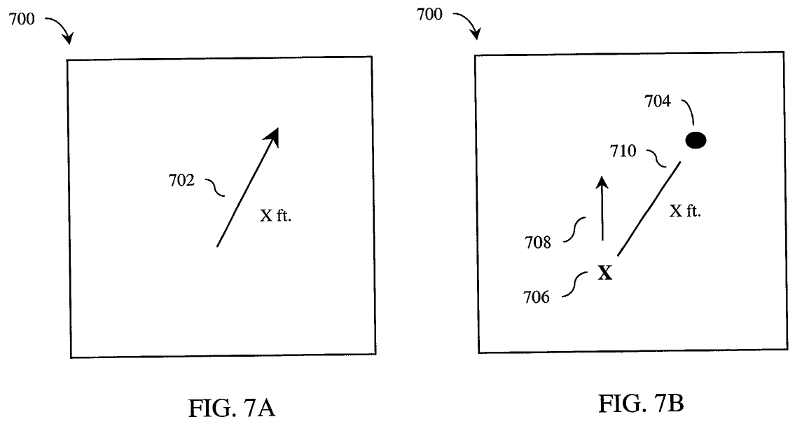

Referring now to FIG. 7A a further aspect of a disclosed system is shown. FIG. 7A includes a display 700 and a pointer 702. In this embodiment, the pointer 702 is configured to direct the user to their vehicle. This embodiment provides the advantage that the user does not need to know which direction is North. Furthermore, the phone does not need to overlay a map.

In the embodiment of FIG. 7A, the user may begin to walk in any direction after activating the disclosed system. While user is walking, the direction the user is walking in may be determined via the use of the position location techniques referenced above.

In one aspect of the present disclosure, the phone's position is continuously tracked via multi-fix position location techniques known in the art over a period of time (e.g., seconds). The phone or a server with which the phone is communicating may compare the change location over these various location fixes to determine the direction that the phone is traveling. In one embodiment, it may be possible to determine the direction that the phone is traveling in with a single fix, because the measurements of a single fix take place over a period of time rather than in a single instant.

Once the direction of travel is determined, a vector pointer 702 may be displayed on display 700, indicating both the direction and distance need to arrive at the vehicle.

Thus, in the embodiment of FIG. 7A, the vector pointer will be displayed in relation to the direction of travel, and not in the orientation of the phone. Thus, the disclosed system will guide the user to their vehicle in relation to the direction in which a user is walking.

FIG. 7B shows yet a further disclosed aspect. In the embodiment of FIG. 7B the display 700 may include a vehicle location indicator 704 and a user location indicator 706. The display 700 may further include a vector direction indicator for indicating which direction the user is traveling. The display 700 may further include a distance indicator 710 that indicates the distance and direction from the user to their vehicle. The display 700 may update at a predetermined refresh rate, every 3-5 seconds, for example, to account for the new path taken by the user. For example, when the user turns and/or gets closer to the car, the display 700 may refresh to show the user's progress.

In any of the above embodiments, the determination of the current location of the phone may involve a connection to a server, such as the PDE in gpsONE. Alternatively, the current location may be determined without the connection to a server, such as in a pure GPS solution as described above.

The previous description of various embodiments, which include preferred embodiments, is provided to enable any person skilled in the art to make or use the present invention. The various modifications to these embodiments will be readily apparent to those skilled in the art, and the generic principles defined herein may be applied to other embodiments without the use of the inventive faculty. Thus, the present disclosure is not intended to be limited to the embodiments shown herein but is to be accorded the widest scope consistent with the principles and novel features disclosed herein.

What is claimed is:

1. A system for locating a vehicle comprising:
a terminal configured to receive vehicle location information from a vehicle over a communication link, compare said vehicle location information with the location of said terminal, and display information to a user enabling said user to locate said vehicle.

2. The system of claim 1, wherein said system is CDMA-compliant.

3. The system of claim 1, wherein said system is disposed within a GPS environment.

4. The system of claim 1, wherein said vehicle further includes a location module for determining the location of said vehicle.

5. The system of claim 4, wherein said location module further includes a location processor for determining the location of said vehicle in a strictly CDMA terrestrial system having no satellites.

6. The system of claim 1, wherein said vehicle further includes a communication module.

7. The system of claim 6, wherein said communication module is configured to provide Bluetooth connectivity.

8. The system of claim 6, wherein said communication module is configured to provide a CDMA communications link.

9. The system of claim 1, wherein said terminal further includes a location module for determining the location of said vehicle.

10. The system of claim 9, wherein said terminal further includes a location processor for determining the location of said vehicle in a strictly CDMA terrestrial system having no satellites.

11. The system of claim 1, wherein said terminal further includes a communication module.

12. The system of claim 11, wherein said communication module is configured to provide Bluetooth connectivity.

13. The system of claim 12, wherein said communication module is configured to provide a CDMA communications link.

14. The system of claim 1, wherein said terminal is configured to remain in a low-power standby mode when not in use.

15. The system of claim 1, wherein said terminal is configured to provide CDMA-based communication services.

16. The system of claim 1, wherein said terminal further includes a display area for providing location information to a user.

17. The system of claim 16, wherein said terminal compares the location of said terminal to the location of said vehicle.

18. The system of claim 17, wherein said terminal compares the location of said terminal to the location of said vehicle by using a cached location of said vehicle.

19. The system of claim 17, wherein said terminal compares the location of said terminal to the location of said vehicle by using a cellular link to retrieve request the location of said vehicle.

20. The system of claim 17, wherein said terminal displays the location of said terminal in relation to the location of said vehicle on said display area.

21. The system of claim 20, wherein said display includes the location of said terminal and the location of said vehicle.

22. The system of claim 21, wherein said display further includes a distance indicator.

23. The system of claim 22, wherein said display further includes an altitude indicator.

24. The system of claim 16, wherein said display further includes a map overlaid on said display.

25. The system of claim 17, wherein said display area further includes a pointer configured to direct the user to said vehicle.

26. The system of claim 17, wherein said terminal compares the location of said terminal to the location of said vehicle by using multi-fix position techniques.

27. The system of claim 26, wherein said display area further includes a vector pointer for indicating both the direction and distance needed to arrive at said vehicle.

28. The system of claim 27, wherein said vector pointer is displayed in relation to the user's direction of travel.

29. A method for enabling a user to locate a vehicle using a terminal comprising:
determining, by a position location server, a vehicle's location;
sending, by said position location server, said vehicle's location to the terminal;
comparing, by said terminal, the location of the terminal to said vehicle's location; and
displaying, by said terminal, location information enabling said user to locate said vehicle.

30. The method of claim 29, wherein said position location server comprises a gpsOne server.

31. The method of claim 29, wherein said position location server comprises a networked-based server.

32. The method of claim 29, wherein said position location server is CDMA-compliant.

33. The method of claim 29, wherein said position location server is disposed within a GPS environment.

34. The method of claim 29, wherein said act of determining, by a position location server, a vehicle's location is performed by a location module disposed within said vehicle.

35. The method of claim 34, wherein said location module further includes a location processor for determining the location of said vehicle in a strictly CDMA terrestrial system having no satellites.

36. The method of claim 29, wherein said act of sending, by said position location server, said vehicle's location to the terminal is performed by a communication module disposed within said vehicle.

37. The method of claim 36, wherein said communication module is configured to provide Bluetooth connectivity.

38. The method of claim 36, wherein said communication module is configured to provide a CDMA communications link.

39. The method of claim 29, wherein said act of comparing, by said terminal, the location of the terminal to said vehicle's location is performed by a location module disposed within said terminal.

40. The method of claim 39, wherein said location processor determines the location of said vehicle in a strictly CDMA terrestrial system having no satellites.

41. The method of claim 29, wherein said terminal receives said vehicle location with a communication module.

42. The method of claim 41, wherein said communication module is configured to provide Bluetooth connectivity.

43. The method of claim 41, wherein said communication module is configured to provide a CDMA communications link.

44. The method of claim 29, wherein said act of displaying, by said terminal, location information enabling said user to locate said vehicle is performed by a display area disposed within said terminal.

45. The method of claim 44, further including the act of comparing the location of said terminal to the location of said vehicle by using a cached location of said vehicle.

46. The method of claim 44, further including the act of comparing the location of said terminal to the location of said vehicle by using a cellular link to retrieve request the location of said vehicle.

47. The method of claim 44, further including the act of displaying the location of said terminal in relation to the location of said vehicle on said display area.

48. The method of claim 44, further including the act of displaying the location of said terminal and the location of said vehicle.

49. The method of claim 48, further including the act of displaying a distance indicator.

50. The method of claim 49, further including the act of displaying an altitude indicator.

51. The method of claim 44, further including the act of overlaying a map on said display.

52. The method of claim 44, further including the act of displaying a pointer configured to direct the user to said vehicle.

53. The method of claim 29, wherein said act of comparing, by said terminal, the location of the terminal to said vehicle's location, is performed by using multi-fix position techniques.

54. The method of claim 53, further including the act of displaying a vector pointer for indicating both the direction and distance needed to arrive at said vehicle.

55. The method of claim 54, further including the act of displaying said vector pointer in relation to the user's direction of travel.

56. A method for enabling a user to locate a vehicle using a terminal comprising:
determining, by the vehicle, its location;
sending, by said vehicle, said location to the terminal over a communications link;
comparing, by said terminal, the location of the terminal to said vehicle location; and
displaying, by said terminal, location information enabling said user to locate said vehicle.

57. The method of claim 56, wherein said communications link is CDMA-compliant.

58. The method of claim 56, wherein said vehicle is disposed within a GPS environment.

59. The method of claim 56, wherein said act of determining, by said vehicle, its location, is performed by a location module disposed within said vehicle.

60. The method of claim 59, wherein said location module further includes a location processor for determining the location of said vehicle in a strictly CDMA terrestrial system having no satellites.

61. The method of claim 56, wherein said act of sending, by said vehicle location to the terminal is performed by a communication module disposed within said vehicle.

62. The method of claim 61, wherein said communication module is configured to provide Bluetooth connectivity.

63. The method of claim 61, wherein said communication module is configured to provide a CDMA communications link.

64. The method of claim 56, wherein said act of comparing, by said terminal, the location of the terminal to said vehicle location is performed by a location module disposed within said terminal.

65. The method of claim 64, wherein said location processor determines the location of said vehicle in a strictly CDMA terrestrial system having no satellites.

66. The method of claim 56, wherein said terminal receives said vehicle location with a communication module.

67. The method of claim 66, wherein said communication module is configured to provide Bluetooth connectivity.

68. The method of claim 67, wherein said communication module is configured to provide a CDMA communications link.

69. The method of claim 56, wherein said act of displaying, by said terminal, location information enabling said user to locate said vehicle is performed by a display area disposed within said terminal.

70. The method of claim 69, further including the act of comparing the location of said terminal to the location of said vehicle by using a cached location of said vehicle.

71. The method of claim 69, further including the act of comparing the location of said terminal to the location of said vehicle by using a cellular link to retrieve request the location of said vehicle.

72. The method of claim 69, further including the act of displaying the location of said terminal in relation to the location of said vehicle on said display area.

73. The method of claim 69, further including the act of displaying the location of said terminal and the location of said vehicle.

74. The method of claim 73, further including the act of displaying a distance indicator.

75. The method of claim 74, further including the act of displaying an altitude indicator.

76. The method of claim 69, further including the act of overlaying a map on said display.

77. The method of claim 69, further including the act of displaying a pointer configured to direct the user to said vehicle.

78. The method of claim 56, wherein said act of comparing, by said terminal, the location of the terminal to said vehicle's location, is performed by using multi-fix position techniques.

79. The method of claim 69, further including the act of displaying a vector pointer for indicating both the direction and distance needed to arrive at said vehicle.

80. The method of claim 79, further including the act of displaying said vector pointer in relation to the user's direction of travel.
